(19) United States
(12) Patent Application Publication
(10) Pub. No.: US 2025/0364914 A1
(43) Pub. Date: Nov. 27, 2025

(54) CONTROL CIRCUIT AND CONTROL METHOD FOR FLYBACK CONVERTER, AND SWITCHING POWER SUPPLY

(71) Applicant: Joulwatt Technology Co., Ltd., Hangzhou (CN)

(72) Inventors: Changwei GONG, Hangzhou (CN); Junming ZHANG, Hangzhou (CN); Yuexia HU, Hangzhou (CN)

(21) Appl. No.: 19/215,508

(22) Filed: May 22, 2025

(30) Foreign Application Priority Data
May 24, 2024 (CN) 202410658885.8

(51) Int. Cl. H02M 3/335

(52) U.S. Cl. CPC H02M 3/33592

(57) ABSTRACT

A control circuit and a control method for a flyback converter, and switching power supply are disclosed. The secondary side control circuit includes a volt-second acquisition unit and a volt-second determination unit. The volt-second acquisition unit calculates the volt-second product of the voltage across the secondary winding. The volt-second determination unit compares the volt-second product with a volt-second threshold to determine the communication status between the primary side control circuit and the secondary side control circuit. This detection process achieves a handshake between the primary and secondary sides and enables precise control of the primary side by the secondary side without the need for additional isolators, reducing circuit cost and loss.

### CROSS-REFERENCE TO PRIOR APPLICATIONS

This application claims priority to Chinese Patent Application No. 202410658885.8, filed on May 24, 2024, entitled “CONTROL CIRCUIT AND CONTROL METHOD FOR FLYBACK CONVERTER, AND SWITCHING POWER SUPPLY,” the contents of which are incorporated herein by reference, including the full text of the specification, claims, drawings, and abstract.

### TECHNICAL FIELD

The present disclosure relates to the field of power electronics technology, specifically to a control circuit and control method for a flyback converter, and a switching power supply.

### BACKGROUND

With the rapid development of electronic systems, there is an increasing demand for high power density and high efficiency switching power converters. Flyback switching power supplies, forward switching power supplies, dual-clamp ZVS converters, etc., have been widely studied and applied due to their high efficiency, full-range soft switching, and adaptability to high switching frequencies.

Common flyback switching power supply topologies include a main power switch transistor, a transformer, and a secondary rectifier transistor. The transformer includes a primary winding and a secondary winding, with the main power switch transistor connected to the primary winding and the secondary rectifier transistor connected to the secondary winding. A synchronous rectifier switch transistor is typically used as the secondary switch transistor to improve system conversion efficiency, and both the primary and secondary sides are controlled by their respective control circuits to control the on and off states of the switch transistors.

Current implementations connect an isolator between the primary side control circuit and the secondary side control circuit for signal transmission, allowing the secondary side control circuit to obtain the conduction information of the primary side, thereby avoiding simultaneous conduction of the main power transistor and the synchronous rectifier transistor, which could damage the system. However, the additional isolator occupies a large area and increases system cost.

### SUMMARY

To solve the above technical problems, the present disclosure provides a control circuit and control method for a flyback converter, and a switching power supply, achieving precise control of the primary side by the secondary side without the need for an isolator.

According to one aspect of the present disclosure, a control circuit for a flyback converter is provided. The flyback converter includes a transformer with a primary winding and a secondary winding, a main power transistor connected to the primary winding, and a synchronous rectifier transistor connected to the secondary winding. The control circuit of the flyback converter includes a primary side control circuit and a secondary side control circuit. The secondary side control circuit comprises: a first control driver configured to send a first turn-on signal to the synchronous rectifier transistor in accordance with a compensation signal to turn on the synchronous rectifier transistor, so that a negative current is generated on the main power transistor; a volt-second acquisition unit configured to calculate the volt-second product of the voltage across the secondary winding within a first time period after generating the first turn-on signal; a volt-second determination unit configured to compare the volt-second product with a volt-second threshold to determine communication status between the primary side control circuit and the secondary side control circuit, wherein the volt-second product, if being greater than the volt-second threshold, indicates a successful handshake between the primary side control circuit and the secondary side control circuit, the compensation signal represents an error between an output feedback signal and a reference signal of the flyback converter.

Optionally, the volt-second product, if being greater than the volt-second threshold, indicates that the primary side control circuit has received and executed the control command from the secondary side control circuit to turn on the main power transistor.

Optionally, the primary side control circuit turns on the main power transistor after detecting that the drain-source voltage of the main power transistor reaches a valley.

Optionally, the flyback converter further includes a sampling resistor connected to the main power transistor. The primary side control circuit detects a voltage signal across the sampling resistor to determine whether the secondary side control circuit has sent the control command. When the voltage signal is less than a first reference voltage, it indicates that the secondary side control circuit has sent the control command. The first reference voltage is a negative voltage. The primary side control circuit responds to the control command by controlling the main power transistor to turn on after detecting that the voltage signal is less than the first reference voltage.

Optionally, if the volt-second determination unit does not detect that the volt-second product is greater than the volt-second threshold during the time period from generating the M-th first turn-on signal to generating the N-th first turn-on signal, it is determined that the primary side control circuit has not executed the control command, and the handshake between the primary side control circuit and the secondary side control circuit has failed, where M is greater than or equal to 1, N is greater than 1, and N is greater than M.

Optionally, the secondary side control circuit, after determining that the handshake between the primary side control circuit and the secondary side control circuit has failed, controls the first control driver to stop working.

Optionally, the primary side control circuit, after a second time period is exceeded without detecting that the voltage signal is less than the first reference voltage, indicates that the handshake between the primary side control circuit and the secondary side control circuit has failed.

Optionally, the primary side control circuit, after determining that the handshake between the primary side control circuit and the secondary side control circuit has failed, automatically restarts or performs fault latching and waits for power-off restart.

Optionally, the secondary side control circuit further includes: a second control driver configured to send a second turn-on signal to the synchronous rectifier transistor to turn it on when the volt-second product is greater than the volt-second threshold and the drain-source voltage of the synchronous rectifier transistor decreases below a threshold voltage.

Optionally, the second control driver is coupled to the volt-second determination unit and stops working when the volt-second determination unit determines that the primary side control circuit has not executed the control command.

Optionally, the first control driver adjusts the generation timing of the first turn-on signal according to the compensation signal to adjust the time period of the switching period.

Optionally, the secondary side control circuit further includes: a freewheeling determination unit configured to determine the operating state of the synchronous rectifier transistor according to a first node voltage at the connection node of the secondary winding and the synchronous rectifier transistor. The first control driver send the first turn-on signal to the synchronous rectifier transistor when the freewheeling determination unit has detected an end of freewheeling of the synchronous rectifier transistor and an operating frequency reaches a preset frequency obtained according to the compensation signal.

Optionally, the volt-second acquisition unit includes: an integration calculation unit configured to perform integration calculation according to the first node voltage at the connection node of the secondary winding and the synchronous rectifier transistor and the output voltage within the first time period to obtain the volt-second product; a volt-second reset unit configured to set the first time period, control the integration calculation unit to start working at the start of the first time period, and control the integration calculation unit to clear the volt-second product at the end of the first time period.

Optionally, the volt-second reset unit sets the time point that a rising edge of the first turn-on signal occurs as the start of the first time period, and the volt-second threshold is a volt-second reference value.

Optionally, the volt-second reset unit sets the time point that a falling edge of the first turn-on signal occurs as the start of the first time period, and the volt-second threshold is the sum of the volt-second reference value and a first volt-second product, wherein the first volt-second product is generated by performing an integration operation based on a voltage across the secondary winding during an on time of the synchronous rectifier transistor controlled by the first turn-on signal.

Optionally, the volt-second reference value is greater than a second volt-second product generated based on the voltage across the secondary winding during parasitic decay oscillation, and the volt-second reference value is less than a third volt-second product generated based on the voltage across the secondary winding during an on time of the main power transistor.

Optionally, the secondary side control circuit further includes: a counting unit configured to count the number of pulses of the first turn-on signal and clear the count value when the volt-second determination unit determines that the volt-second product is greater than the volt-second threshold; and an alarm unit configured to output an alarm signal when the count value of the counting unit exceeds a preset value, to provide the alarm signal to the first control driver, or to provide the alarm signal simultaneously to the first control driver and the second control driver.

Optionally, the primary side control circuit includes: a negative voltage detection unit configured to detect the voltage signal across the sampling resistor and compare it with the first reference voltage, and to output a first preparation signal when detecting that the voltage signal is less than the first reference voltage; a third control driver configured to output a third turn-on signal to the main power transistor after receiving the first preparation signal, controlling the main power transistor to be turned on; and a timing alarm unit triggered by a clock signal to start timing, resetting upon receiving the first preparation signal, and generating an alarm signal when continuously timing exceeds the second time period without resetting.

According to another aspect of the present disclosure, a control method for a flyback converter is provided. The flyback converter includes a transformer with a primary winding and a secondary winding, a main power transistor connected to the primary winding, and a synchronous rectifier transistor connected to the secondary winding. The control method of the flyback converter comprises: sending a first turn-on signal to the synchronous rectifier transistor in accordance with a compensation signal to turn on the synchronous rectifier transistor, so that a negative current is generated on the main power transistor; calculating the volt-second product of the voltage across the secondary winding within a first time period after generating the first turn-on signal; comparing the volt-second product with a volt-second threshold to determine communication status between the primary side control circuit and the secondary side control circuit, wherein the volt-second product, if being greater than the volt-second threshold, indicates a successful handshake between the primary side control circuit and the secondary side control circuit, the compensation signal represents an error between the output feedback signal and the reference signal of the flyback converter.

Optionally, the volt-second product, if being greater than the volt-second threshold, indicates that the primary side control circuit has received and executed the control command from the secondary side control circuit to turn on the main power transistor.

Optionally, the control method further includes: determining that the primary side control circuit has not executed the control command and the handshake between the primary side control circuit and the secondary side control circuit has failed if the volt-second product is not detected to be greater than the volt-second threshold during the time period from generating the M-th first turn-on signal to generating the N-th first turn-on signal, where M is greater than or equal to 1, N is greater than 1, and N is greater than M.

Optionally, the flyback converter further includes a sampling resistor connected to the main power transistor. The control method further includes: detecting a voltage signal across the sampling resistor to determine whether the secondary side control circuit has sent the control command. When the voltage signal is less than a first reference voltage, it indicates that the secondary side control circuit has sent the control command. The first reference voltage is a negative voltage. The control method responds to the control command by controlling the main power transistor to turn on after detecting that the voltage signal is less than the first reference voltage.

Optionally, the control method further includes: indicating that the handshake between the primary side control circuit and the secondary side control circuit has failed if the voltage signal is not detected to be less than the first reference voltage after a second time period is exceeded.

Optionally, the control method further includes: sending a second turn-on signal to the synchronous rectifier transistor to turn it on when the volt-second product is greater than the volt-second threshold and the drain-source voltage of the synchronous rectifier transistor decreases below a threshold voltage.

Optionally, the step of sending a first turn-on signal to the synchronous rectifier transistor according to a compensation signal to turn on the synchronous rectifier transistor, so that a negative current is generated on the main power transistor, includes: sending the first turn-on signal to the synchronous rectifier transistor when an end of freewheeling of the synchronous rectifier transistor has been detected and an operating frequency reaches a preset frequency obtained according to the compensation signal, and adjusting the time period of the switching period by adjusting the generation timing of the first turn-on signal.

According to another aspect of the present disclosure, a switching power supply is provided, including a flyback converter. The flyback converter includes a transformer with a primary winding and a secondary winding, a main power transistor connected to the primary winding, and a synchronous rectifier transistor connected to the secondary winding. The switching power supply further includes: the control circuit of the flyback converter as mentioned above, the control circuit of the flyback converter being configured to control the operating states of the main power transistor and the synchronous rectifier transistor.

The control circuit and the control method for a flyback converter, and the switching power supply provided by the present disclosure enable the secondary side control circuit to send a first turn-on signal to the synchronous rectifier transistor according to a compensation signal to turn on the synchronous rectifier transistor, so that a negative current is generated on the main power transistor. The presence of this negative current allows the main power transistor to achieve zero voltage switching (ZVS), reducing system loss. The secondary side control circuit calculates the volt-second product of the voltage across the secondary winding within a first time period after generating the first turn-on signal and compares the volt-second product with a volt-second threshold to determine the communication status between the primary side control circuit and the secondary side control circuit. The volt-second product, if being greater than the volt-second threshold, indicates a successful handshake between the primary side control circuit and the secondary side control circuit, also indicating that the main power transistor is operating normally. This indicates that the primary side control circuit has successfully received and executed the control command from the secondary side control circuit, allowing the main power transistor to turn on, thereby completing the handshake communication between the primary and secondary sides without an isolator. Through the above control circuit and control method, the secondary side control circuit can act as the main control chip, determining the operating state of the primary side control circuit, achieving handshake communication without an isolator, reducing circuit area and system cost, and lowering power consumption.

Furthermore, the primary side control circuit detects the voltage signal across the sampling resistor. When the voltage signal is less than the first reference voltage, it is considered that a negative current has been generated, indicating that the primary side control circuit has received the control command from the secondary side control circuit, allowing it to execute the control command to turn on the main power transistor. Therefore, the secondary side control circuit can control the operating state of the primary side control circuit, further controlling the turn-on timing of the main power transistor without additional isolators, achieving precise control.

Furthermore, if the volt-second determination unit does not detect that the volt-second product is greater than the volt-second threshold during the time period in which the first control driver generates two or even multiple first turn-on signals, it is determined that the primary side control circuit has not executed the control command, and the primary side control circuit may have a fault. At this time, it is determined that the handshake between the primary side control circuit and the secondary side control circuit has failed. Alternatively, if the primary side control circuit does not detect that the voltage signal is less than the first reference voltage after continuously exceeding the second time period, it is considered that the secondary side control circuit may have a fault, and at this time, it is also determined that the handshake between the primary side control circuit and the secondary side control circuit has failed. Therefore, the circuit can be accurately judged whether it is communicating normally in accordance with two judgment parameters, and appropriate measures can be taken in a timely manner when communication is not normal, improving the accuracy of communication interaction.

Furthermore, when the secondary-side control circuit determines that a potential fault in the primary-side control circuit has led to a handshake failure between the primary and secondary sides, it will control the first control drive unit to stop working and will not send the first conduction signal, so that the primary-side control chip will not detect negative voltage information. Moreover, when the primary-side control circuit determines that a potential fault in the secondary-side control circuit has led to a handshake failure, it will automatically restart the primary-side control chip, or perform fault latching on the primary-side control chip and wait for a power-down restart. Thus, when a handshake failure occurs, the sending of the turn-on signal can be stopped, and the primary-side control chip will be actively or passively restarted, the secondary side will be re-energized, and the communication process will gradually resume, restoring operation, ensuring the circuit operates well, and preventing circuit damage.

Furthermore, after the secondary side control circuit determines that the main power transistor has successfully turned on in accordance with the volt-second product, it can output a second turn-on signal to the synchronous rectifier transistor and adjust the length of the switching period by controlling the generation timing of the first turn-on signal, thereby adjusting the switching frequency. The secondary side control circuit achieves closed-loop control, determining the system's operating frequency and the turn-on timing of the main power transistor, ensuring the stability and reliability of system communication.

Furthermore, when calculating the volt-second product, the influence of the volt-second product on the secondary winding during the period when the synchronous rectifier transistor is turned on after receiving the first turn-on signal is considered, avoiding misjudgment caused by changes in the volt-second product when the main power transistor is not turned on but the synchronous rectifier transistor is already turned on, thereby avoiding the phenomenon of simultaneous conduction of the synchronous rectifier transistor and the main power transistor.

Furthermore, the interaction results of multiple switching periods can be used to determine whether the flyback converter is operating normally, improving system reliability.

It should be noted that the above general description and the detailed description below are merely exemplary and explanatory and do not limit the present disclosure.

### BRIEF DESCRIPTION OF THE DRAWINGS

FIG. 1 shows a schematic circuit diagram of a switching power supply according to an embodiment of the present disclosure;

FIG. 2 shows a schematic flowchart of a control method for a flyback converter according to an embodiment of the present disclosure;

FIGS. 3 and 4 respectively show a schematic block diagram and a schematic circuit diagram of a secondary side control circuit of a control circuit for a flyback converter according to an embodiment of the present disclosure;

FIGS. 5 and 6 respectively show a schematic block diagram and a schematic circuit diagram of a primary side control circuit of a control circuit for a flyback converter according to an embodiment of the present disclosure;

FIG. 7 shows a schematic waveform diagram of various signals when the switching power supply according to an embodiment of the present disclosure is operating normally;

FIG. 8 shows a schematic waveform diagram of various signals when a fault occurs in the primary side control circuit or the secondary side control circuit of the switching power supply according to an embodiment of the present disclosure.

### DETAILED DESCRIPTION

To facilitate understanding of the present disclosure, a more comprehensive description of the present disclosure will be provided below with reference to the relevant drawings. The preferred embodiments of the present disclosure are given in the drawings. However, the present disclosure can be implemented in different forms and is not limited to the embodiments described herein. On the contrary, the provision of these embodiments is to make the disclosure of the present disclosure more thorough and comprehensive.

FIG. 1 shows a schematic circuit diagram of a switching power supply according to an embodiment of the present disclosure. The present disclosure mainly focuses on handshake communication judgment between the primary and secondary sides of a flyback converter, so the switching power supply is a flyback switching power supply.

As shown in FIG. 1, the flyback switching power supply 10 of this embodiment includes a main circuit, a primary side control circuit 100, and a secondary side control circuit 200. The main circuit includes a primary side main power transistor Q1, a secondary side synchronous rectifier transistor Q2, and a transformer T. The transformer T includes a primary winding Np and a secondary winding Ns that are mutually coupled. The main power transistor Q1 and the synchronous rectifier transistor Q2 can be selected as MOS transistors, or GaN transistors, SiC transistors, etc. The source of the main power transistor Q1 is grounded through a sampling resistor Rcs, the drain is connected to the primary winding Np, and the gate is connected to the primary side control circuit 100, controlling the on and off states of the main power transistor Q1 according to the drive signal VDR. The gate of the synchronous rectifier transistor Q2 is connected to the secondary side control circuit 200, controlling the on and off states of the synchronous rectifier transistor Q2 according to a second turn-on signal VGT or a first turn-on signal VGTZ. The source of the synchronous rectifier transistor Q2 is grounded, and the drain is connected to the secondary winding Ns. A diode DI and a capacitor CO are connected between the drain of the main power transistor Q1 and the input power supply Vin on the primary side. A resistor Ri is connected in parallel across the two ends of the capacitor CO. A filter capacitor Ci is also connected between the input power supply Vin and ground. An AC source AC forms the input power supply Vin after passing through a rectifier bridge BD. A filter capacitor Co is connected between the source of the synchronous rectifier transistor Q2 and the homonymous terminal of the secondary winding Ns on the secondary side. The first node voltage Vsw is obtained from the common node of the secondary winding Ns and the synchronous rectifier transistor Q2, and the output voltage Vo is obtained from the output terminal. The difference between the first node voltage Vsw and the output voltage Vo is the voltage across the secondary winding. The flyback converter may also include an auxiliary winding Na, which is coupled with the primary winding Np. A first resistor R1 and a second resistor R2 are connected in series across the two ends of the auxiliary winding Na. The second node voltage Vs is provided at the common node of the first resistor R1 and the second resistor R2, and the second node voltage Vs can represent the drain-source voltage across the main power transistor Q1.

The primary side control circuit 100 includes multiple pins, such as a DRV pin, a VS pin, a CS pin, etc. The VS pin is connected to the common node of the first resistor R1 and the second resistor R2, and receives the second node voltage Vs. The CS pin is connected to the common node of the sampling resistor Rcs and the main power transistor Q1, used to obtain the voltage across the sampling resistor Rcs. The DRV pin is connected to the gate of the main power transistor Q1, controlling the operating state of the main power transistor Q1 according to the drive signal VDR. The secondary side control circuit 200 also includes multiple pins, such as a GT pin, an SW pin, a VT pin, and a VO pin, etc. The VO pin receives the output voltage Vo, the SW pin receives the first node voltage Vsw, the VT pin can provide a volt-second reference value through an external resistor, and the GT pin is used to output the second turn-on signal VGT or first turn-on signal VGTZ.

In FIG. 1, during the switching cycle of the switching power supply, when the main power transistor Q1 is turned on, the input voltage Vin magnetizes the transformer T via the main power transistor Q1, and the synchronous rectifier transistor Q2 is turned off. The output filter capacitor Co supports power supply to the load RL. When the main power transistor Q1 is turned off, the synchronous rectifier transistor Q2 is turned on, and the energy stored in the transformer T is transferred to the secondary side to supply power to the load RL, and the capacitor Co is charged.

In this embodiment, the secondary side control circuit 200 includes a first control driver 210, a volt-second acquisition unit 220, and a volt-second determination unit 230. When both the main power transistor Q1 and the synchronous rectifier transistor Q2 are turned off, the first control driver 210 sends a first turn-on signal VGTZ to the synchronous rectifier transistor according to the compensation signal Vcom to turn on the synchronous rectifier transistor Q2, so that a negative current is generated on the main power transistor Q1. The compensation signal Vcom represents an error between the output feedback signal and the reference signal of the flyback converter. The output feedback signal of the flyback converter can be obtained according to the output voltage, output power, or output current, etc. In this embodiment, for example, the compensation signal Vcom can be obtained according to the output voltage Vo. The direction of this negative current is opposite to the direction of the current Ip in FIG. 1. The negative current causes the charge on the parasitic capacitance across the main power transistor Q1 to be released, pulling down the drain-source voltage Vds of the main power transistor Q1 to zero, allowing the main power transistor Q1 to turn on with zero voltage, achieving soft start, reducing the switching loss of the switching power supply to improve the efficiency of the switching power supply. The primary side control circuit 100 detects the voltage signal across the sampling resistor Rcs through the CS pin to determine whether a negative current has appeared on the main power transistor Q1. When the voltage signal Vcs across the sampling resistor Rcs is less than the first reference voltage Vcsref1, which is a negative voltage, it is considered that a negative current has been generated on the main power transistor Q1. Then, after detecting that the drain-source voltage across the main power transistor Q1 has dropped to the valley, a third turn-on signal VDR (GON) is output to the main power transistor Q1 to control the main power transistor Q1 to turn on. Therefore, when the primary side control circuit 100 detects that the voltage signal Vcs is less than the first reference voltage Vcsref1, it also indicates that the primary side control circuit 100 has received the control command from the secondary side control circuit 200 and responds to the control command under the control of the primary side control circuit 100 to turn on the main power transistor Q1.

Moreover, the volt-second acquisition unit 220 of the secondary side control circuit 200 calculates the volt-second product VT of the voltage across the secondary winding Ns within the first time period after generating the first turn-on signal VGTZ. The volt-second determination unit 230 compares the volt-second product VT with the volt-second threshold VTth to determine the operating state of the main power transistor Q1 and the communication status between the primary side control circuit 100 and the secondary side control circuit 200. The first time period can be greater than the on time of the main power transistor Q1, or the first time period can include the on time of the main power transistor Q1. When the secondary side control circuit 200 determines that the volt-second product VT is greater than the volt-second threshold VTth, it indicates that the main power transistor Q1 is operating normally, which means that the primary side control circuit 100 has accepted the control of the secondary side control circuit 200 and can normally turn on the main power transistor Q1. Therefore, after the secondary side control circuit 200 determines that the volt-second product VT is greater than the volt-second threshold VTth, and after detecting that the drain-source voltage of the synchronous rectifier transistor Q2 has decreased to a certain value or the change rate of the drain-source voltage of the synchronous rectifier transistor Q2 meets the condition, a second turn-on signal VGT is provided to the synchronous rectifier transistor Q2 to turn on the synchronous rectifier transistor Q2, and the first turn-on signal VGTZ is continuously output in the next switching cycle. The alternating conduction of the main power transistor Q1 and the synchronous rectifier transistor Q2 can achieve energy transfer. Therefore, when it is determined that the volt-second product is greater than the volt-second threshold, it indicates that the primary side control circuit 100 has received the control command from the secondary side control circuit 200 and executed the control command to turn on the main power transistor Q1, or in other words, when it is determined that the volt-second product is greater than the volt-second threshold, it is determined that the handshake between the primary side control circuit 100 and the secondary side control circuit 200 is successful.

Moreover, if the volt-second determination unit 230 does not detect that the volt-second product is greater than the volt-second threshold during the time period from generating the M-th first turn-on signal VGTZ to generating the N-th first turn-on signal VGTZ (where M is greater than or equal to 1, N is greater than 1, and N is greater than M), it is determined that the primary side control circuit 100 has not executed the control command, and the handshake between the primary side control circuit 100 and the secondary side control circuit 200 has failed. At this time, the secondary side control circuit 200 considers that the primary side control circuit 100 has failed, although it may also be that the secondary side control circuit 200 itself has failed, resulting in the handshake failure between the primary side control circuit 100 and the secondary side control circuit 200. At this time, the secondary side control circuit 200 can generate an alarm signal to control the first control driver 210 to stop working, stopping the sending of the first turn-on signal VGTZ to the synchronous rectifier transistor Q2. Alternatively, if the primary side control circuit 100 does not detect that the voltage signal is less than the first reference voltage after continuously exceeding the second time period, it indicates that the secondary side control circuit 200 has not sent the control command, and the handshake between the primary side control circuit 100 and the secondary side control circuit 200 has failed. At this time, the primary side control circuit 100 considers that the secondary side control circuit 200 has failed, or the primary side control circuit 100 itself has failed. The primary side control circuit 100 automatically restarts, or performs fault latching and waits for power-off restart, or can generate an alarm signal to control the primary side control circuit 100 to stop working. After the primary side control circuit 100 restarts, it controls the main power transistor Q1 to perform switching actions in multiple switching cycles, allowing the secondary side control circuit 200 to be powered and start working again, and then perform primary-secondary communication handshake again.

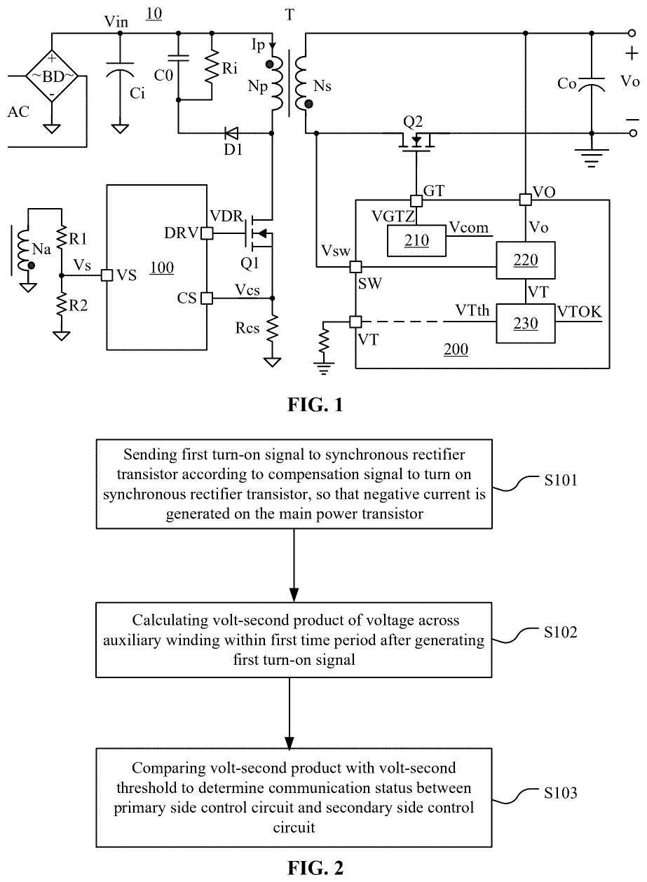

FIG. 2 shows a schematic flowchart of a control method for a flyback converter according to an embodiment of the present disclosure.

The control method for the flyback converter is used in the above switching power supply to control the conduction of the main power transistor Q1 and the synchronous rectifier transistor Q2 in the flyback switching power supply. Referring to FIG. 2, the control method for the flyback converter of this embodiment includes the following steps.

In step S101, a first turn-on signal is sent to the synchronous rectifier transistor according to a compensation signal to turn on the synchronous rectifier transistor, so that a negative current is generated on the main power transistor. The compensation signal Vcom represents an error between the output feedback signal and the reference signal of the flyback converter. The output feedback signal of the flyback converter can be obtained according to the output voltage, output current, or output power, etc.

In step S102, the volt-second product of the voltage across the secondary winding is calculated within the first time period after generating the first turn-on signal.

In step S103, the volt-second product is compared with the volt-second threshold to determine the communication status between the primary side control circuit 100 and the secondary side control circuit 200. The volt-second product, if being greater than the volt-second threshold, indicates a successful handshake between the primary side control circuit 100 and the secondary side control circuit 200. When the volt-second product is greater than the volt-second threshold, it also indicates that the primary side control circuit 100 has received the control command from the secondary side control circuit 200 and executed the control command to turn on the main power transistor Q1.

The above steps S101 to S103 are implemented by the secondary side control circuit 200 to determine whether the primary side control circuit 100 accepts control. Moreover, the control method for the flyback converter may also include judgment steps executed by the primary side control circuit 100, such as: detecting the voltage signal across the sampling resistor to determine whether the secondary side control circuit 200 has sent the control command. When the voltage signal is less than the first reference voltage (negative voltage), it indicates that the secondary side control circuit 200 has sent the control command. Then, in response to the control command, after detecting that the voltage signal is less than the first reference voltage, the main power transistor is controlled to turn on, for example, after the primary side control circuit 100 detects that the voltage signal Vcs is less than the first reference voltage Vcsref1, and after detecting that the drain-source voltage of the main power transistor Q1 has reached the valley, the main power transistor Q1 is turned on. These two steps are used to determine whether the primary side control circuit 100 has received the control from the secondary side control circuit 200. Therefore, the handshake communication between the primary and secondary sides is completed through the above steps, allowing the switching power supply to operate normally. During the period when the synchronous rectifier transistor Q2 is turned on according to the first turn-on signal, it can release the charge on the parasitic capacitance of the main power transistor Q1, thereby achieving ZVS start of the main power transistor Q1. After the main power transistor Q1 is turned off, the secondary side control circuit 200 also needs to control the synchronous rectifier transistor Q2 to turn on for freewheeling according to the second turn-on signal VGT, transferring the energy of the primary winding to the secondary winding. Therefore, in this embodiment, the control method for the flyback converter also includes: after the secondary side control circuit 200 determines that the volt-second product is greater than the volt-second threshold and detects that the drain-source voltage of the synchronous rectifier transistor Q2 has decreased below the threshold voltage (or the change rate of the drain-source voltage of the synchronous rectifier transistor Q2 meets certain conditions), a second turn-on signal VGT is sent to the synchronous rectifier transistor to turn on the synchronous rectifier transistor.

Furthermore, the secondary side control circuit 200 can also determine the operating state of the synchronous rectifier transistor Q2 by detecting the first node voltage Vsw. In DCM (Discontinuous Conduction Mode), when an end of the freewheeling of the synchronous rectifier transistor Q2 has been detected and an operating frequency reaches a preset frequency obtained according to the compensation signal Vcom, the first turn-on signal VGTZ is sent to the synchronous rectifier transistor Q2, and the generation timing of the first turn-on signal VGTZ is adjusted to adjust the length of the switching period. The end of freewheeling of the synchronous rectifier transistor Q2 means that the synchronous rectifier transistor Q2 is turned off and enters the parasitic oscillation stage. Only when the circuit is operating in DCM mode, and the end of the freewheeling of the synchronous rectifier transistor Q2 has been detected, and the operating frequency reaches the preset frequency obtained according to the compensation signal Vcom, does it indicate that a switching period has ended and a new switching period is about to begin. At this time, the first turn-on signal VGTZ is sent to the synchronous rectifier transistor Q2 again. That is, steps S101-S103 are executed again, repeating multiple switching periods.

Furthermore, in step S102, the volt-second product of the voltage across the secondary winding Ns is calculated within the first time period. The first time period can include the on time of the main power transistor Q1. During the on time of the main power transistor Q1, the synchronous rectifier transistor Q2 is turned off, and its drain-source voltage is relatively high, resulting in a large volt-second product. Therefore, when a large value of the volt-second product is detected within the first time period, it is considered that the main power transistor Q1 has been turned on or that the main power transistor Q1 is operating normally. Therefore, the large value of the volt-second product should be greater than the volt-second product generated during the natural oscillation period (parasitic decay oscillation period) in DCM mode. Therefore, a volt-second reference value VTref can be set, which is greater than the second volt-second product VT2 generated based on a voltage across the secondary winding Ns during the parasitic decay oscillation period, and the volt-second reference value VTref is less than the third volt-second product VT3 generated based on a voltage across the secondary winding Ns during the on time of the main power transistor Q1. When the volt-second product is greater than this volt-second reference value VTref, it is considered that the main power transistor Q1 is operating normally.

The start time of the first time period can be near the generation time of the first turn-on signal VGTZ, and the end time of the first time period can be the time when the first node voltage Vsw begins to be less than the output voltage Vo. However, since the first turn-on signal VGTZ causes the synchronous rectifier transistor Q2 to turn on, a volt-second product is generated based on a voltage across the secondary winding Ns, and this volt-second product is also relatively large. When the main power transistor Q1 is not turned on normally, the volt-second product generated due to the influence of the first turn-on signal VGTZ will also be greater than the volt-second product generated during the parasitic decay oscillation period, causing a volt-second misjudgment, resulting in the synchronous rectifier transistor Q2 continuing to turn on. When the main power transistor Q1 is turned on later, there will be a phenomenon of simultaneous conduction, causing the system to work disorderly and even damage the circuit. Therefore, to avoid misjudgment causing simultaneous conduction, compensation for the volt-second product caused by the first turn-on signal VGTZ is required. Therefore, if the start time of the first time period is set as the generation time of the rising edge of the first turn-on signal, the volt-second threshold VTth is set as the volt-second reference value VTref. However, if the start time of the first time period is set as the generation time of the falling edge of the first turn-on signal, the volt-second threshold VTth is set as the sum of the volt-second reference value and the first volt-second product VT1, wherein the first volt-second product VT1 is generated by performing an integration operation based on a voltage across the secondary winding Ns during an on time of the synchronous rectifier transistor Q2 controlled by the first turn-on signal VGTZ.

In this embodiment, the control method for the flyback converter also includes: detecting the voltage signal across the sampling resistor by the primary side control circuit 100, and controlling the main power transistor Q1 to turn off when the voltage signal Vcs is greater than the second reference voltage Vcsref2, where the second reference voltage is a positive voltage. This step is to achieve the turn-off of the main power transistor Q1, which adopts a peak current control strategy, turning off the main power transistor Q1 when the magnetizing current through the primary winding Np reaches the peak value.

In this embodiment, the control method for the flyback converter also includes: if the secondary side control circuit 200 does not detect that the volt-second product is greater than the volt-second threshold during the time period from generating the M-th first turn-on signal VGTZ to generating the N-th (where M is greater than or equal to 1, N is greater than 1, and N is greater than M) first turn-on signal VGTZ, it is determined that the primary side control circuit 100 may not have executed the control command, and the handshake between the primary side control circuit 100 and the secondary side control circuit 200 has failed. Additionally, if the primary side control circuit 100 does not detect that the voltage signal is less than the first reference voltage after continuously exceeding the second time period, it indicates that the secondary side control circuit 200 may not have sent the control command, and the handshake between the primary side control circuit 100 and the secondary side control circuit 200 has failed.

Furthermore, steps S101-S103 describe the interaction process between the primary side control circuit 100 and the secondary side control circuit 200 during normal operation. However, if a fault occurs in the primary side control circuit 100 or the secondary side control circuit 200, the voltage signal sampled on the sampling resistor Rcs by the primary side control circuit 100 will never reach the required negative voltage, the main power transistor Q1 will not turn on on time, and the secondary side control circuit 200 will not detect a normal volt-second product, or the volt-second product will never exceed the volt-second threshold. At this time, it is considered that the circuit has a fault, and an alarm signal can be output after counting when the volt-second product is less than the volt-second threshold in each switching cycle, and/or when the voltage signal is greater than the first reference voltage for more than the second time period. After generating the alarm signal, the secondary side control circuit 200 can be turned off, and the primary side control circuit 100 can be restarted or enter a latch state. Of course, an alarm signal can also be generated after judging multiple switching cycles to enhance the accuracy of the judgment.

In summary, the control method for the flyback converter of this embodiment can achieve ZVS conduction of the main power transistor, achieve handshake communication between the primary and secondary sides, and does not require additional isolators between the primary and secondary sides for communication.

The following describes the control method and control circuit for the flyback converter of the present disclosure in combination with specific circuits.

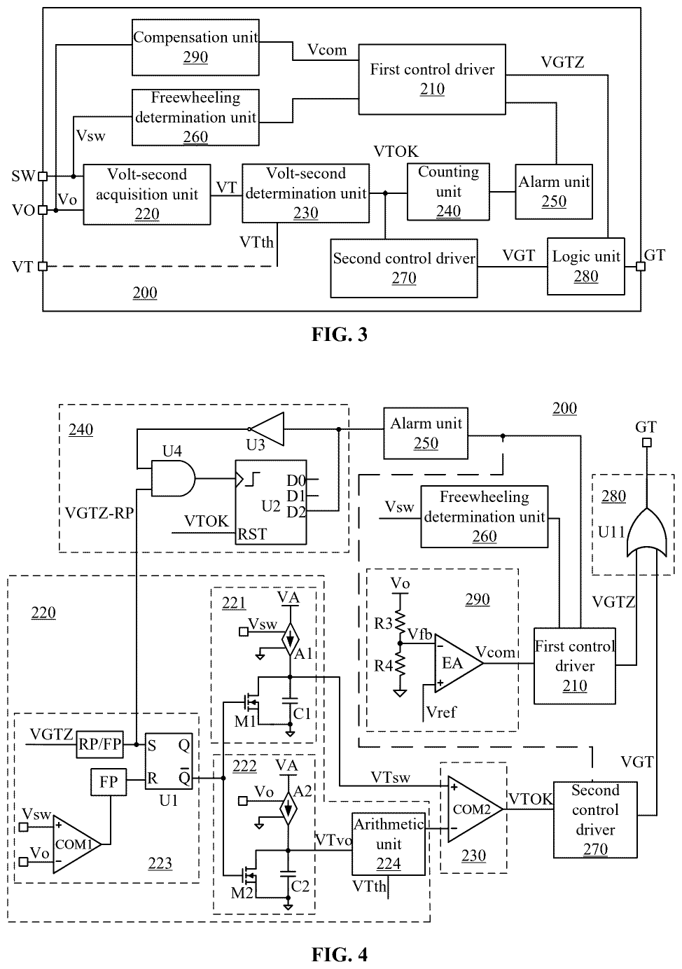

FIGS. 3 and 4 respectively show a schematic block diagram and a schematic circuit diagram of a secondary side control circuit of a control circuit for a flyback converter according to an embodiment of the present disclosure.

As shown in FIGS. 3 and 4, the secondary side control circuit 200 includes a first control driver 210, a volt-second acquisition unit 220, a volt-second determination unit 230, a counting unit 240, an alarm unit 250, a freewheeling determination unit 260, a second control driver 270, a logic unit 280, and a compensation unit 290.

The compensation unit 290 is used to provide a compensation signal Vcom representing the output feedback signal and the error signal of the flyback converter. The output feedback signal of the flyback converter can be obtained according to the output voltage, output power, or output current, etc. The compensation unit 290 can generate the compensation signal Vcom according to the output voltage Vo. For example, the compensation unit 290 includes a third resistor R3, a fourth resistor R4, and an error amplifier EA. Specifically, a third resistor R3 and a fourth resistor R4 are connected in series between the output terminal and ground of the flyback converter, and a feedback voltage Vfb representing the output voltage is provided at the common node of the third resistor R3 and the fourth resistor R4. One input terminal of the error amplifier EA receives the feedback voltage Vfb, the other input terminal receives the reference voltage Vref, and the output terminal outputs the compensation signal Vcom. Of course, the compensation unit 290 can also use other circuit structures to generate the compensation signal Vcom, and is not limited to this method. The first control driver 210 receives the compensation signal Vcom from the compensation unit 290 and sends a first turn-on signal VGTZ to the synchronous rectifier transistor Q2 from the GT pin to turn on the synchronous rectifier transistor Q2, so that a negative current is generated on the main power transistor Q1. The freewheeling determination unit 260 is used to determine the operating state of the synchronous rectifier transistor Q2 according to the first node voltage Vsw at the connection node of the secondary winding and the synchronous rectifier transistor. Alternatively, the operating state of the synchronous rectifier transistor Q2 is determined according to the first node voltage Vsw and the output voltage Vo together. The freewheeling determination unit 260 is used to detect whether the circuit is operating in DCM. Only when it is detected that the freewheeling of the synchronous rectifier transistor Q2 has ended in DCM, does the first control driver 210 determine whether to output the first turn-on signal VGTZ according to the compensation signal Vcom. That is, the freewheeling determination unit 260, after the end of the freewheeling of the synchronous rectifier transistor Q2 has been detected in DCM and the operating frequency reaches the preset frequency obtained according to the compensation signal Vcom, the first control driver 210 sends the first turn-on signal VGTZ to the synchronous rectifier transistor Q2.

The volt-second acquisition unit 220 obtains the first node voltage Vsw and the output voltage Vo from the SW pin and the VO pin, respectively, to calculate the volt-second product VT of the voltage across the secondary winding Ns within the first time period after generating the first turn-on signal VGTZ. The volt-second determination unit 230 is connected to the volt-second acquisition unit 220 and compares the volt-second product VT with the volt-second threshold VTth to determine the operating state of the main power transistor Q1. When the volt-second product VT is greater than the volt-second threshold VTth, a VTOK signal is generated, indicating that the main power transistor Q1 is operating normally and that the handshake between the primary and secondary sides is successful. For example, the volt-second determination unit 230 can include a comparator COM2. The volt-second threshold VTth can be generated by the VT pin through an external resistor, or directly generated inside the chip. The second control driver 270 is connected to the volt-second determination unit 230 and sends a second turn-on signal VGT to the synchronous rectifier transistor Q2 to turn on the synchronous rectifier transistor Q2 when the volt-second product VT is greater than the volt-second threshold VTth (or when the VTOK signal is generated) and the drain-source voltage of the synchronous rectifier transistor Q2 decreases below the threshold voltage. The first control driver 210 also adjusts the length of the switching period by adjusting the generation timing of the first turn-on signal VGTZ.

The counting unit 240 is connected to the volt-second determination unit 230 and counts the number of pulses of the first turn-on signal VGTZ, and clears the count value when the volt-second determination unit 230 determines that the volt-second product VT is greater than the volt-second threshold VTth. Alternatively, the counting unit 240 starts counting each time it receives the first turn-on signal VGTZ and resets the count value when the volt-second product VT is greater than the volt-second threshold VTth. Therefore, if the volt-second product VT cannot always be greater than the volt-second threshold VTth, continuous counting is performed, counting multiple pulse numbers continuously, or the count value cannot always be reset. The alarm unit 250 is connected to the counting unit 240 and can output an alarm signal when the count value of the counting unit 240 exceeds a preset value. That is, when the volt-second product does not reach the volt-second threshold in at least one switching cycle, it is considered that the circuit has a fault, and an alarm signal is generated. The alarm unit 250 can also be connected to the first control driver 210, and when the volt-second product does not reach the volt-second threshold in multiple consecutive switching cycles, and multiple count values are detected, an alarm signal is output to control the first control driver 210 to stop working. Of course, the alarm unit 250 can also control the second control driver 270 to stop working according to the alarm signal, or simultaneously control the first control driver 210 and the second control driver 270 to stop working.

The first turn-on signal VGTZ generated by the first control driver 210 and the second turn-on signal VGT generated by the second control driver 270 are both sent to the synchronous rectifier transistor Q2 from the GT pin, so a logic unit 280 can be added between the first control driver 210 and the second control driver 270. The logic unit 280 can include an OR gate U11, used to select the first turn-on signal or the second turn-on signal for output.

Furthermore, the volt-second acquisition unit 220 can include an integration calculation unit and a volt-second reset unit. The integration calculation unit performs integration calculation according to the first node voltage Vsw at the connection node of the secondary winding Ns and the synchronous rectifier transistor Q2 and the output voltage Vo within the first time period to obtain the volt-second product. The volt-second reset unit is used to set the first time period, control the integration calculation unit to start working at the start of the first time period, and control the integration calculation unit to clear the volt-second product at the end of the first time period. Furthermore, in one embodiment, for example, a circuit structure shown in FIG. 4, the volt-second acquisition unit 220 can include a first integration unit 221, a second integration unit 222, a volt-second reset unit 223, and an arithmetic unit 224. The first integration unit 221 performs integration on the first node voltage Vsw at the connection node of the secondary winding and the synchronous rectifier transistor Q2 within the first time period to obtain the first integration voltage VTsw. The second integration unit 222 performs integration on the output voltage Vo within the first time period to obtain the second integration voltage VTvo. The volt-second reset unit 223 is connected to the first integration unit 221 and the second integration unit 222, used to set the first time period. At the start time of the first time period, the first integration unit 221 and the second integration unit 222 are controlled to start working, and at the end time of the first time period, the first integration unit 221 and the second integration unit 222 respectively clear the first integration voltage VTsw and the second integration voltage VTvo. The arithmetic unit 224 is used to calculate the difference between the first integration voltage VTsw and the second integration voltage VTvo, or to calculate the sum of the second integration voltage VTvo and the volt-second threshold VTth.

Furthermore, the volt-second reset unit 223 sets the generation time of the rising edge of the first turn-on signal as the start time of the first time period, and the volt-second threshold VTth is correspondingly set as the volt-second reference value VTref. The volt-second reset unit 223 sets the generation time of the falling edge of the first turn-on signal as the start time of the first time period, and the volt-second threshold VTth is correspondingly set as the sum of the volt-second reference value VTref and the first volt-second product VT1, wherein the first volt-second product VT1 is generated by performing an integration operation based on a voltage across the secondary winding Ns during an on time of the synchronous rectifier transistor Q2 controlled by the first turn-on signal VGTZ. The volt-second reference value VTref is greater than the second volt-second product VT2 generated according to the voltage across the secondary winding Ns during the parasitic decay oscillation period, and the volt-second reference value VTref is less than the third volt-second product VT3 generated according to the voltage across the secondary winding Ns during the on time of the main power transistor Q1.

In one embodiment, the volt-second reset unit 223 includes a first comparator COM1 and a first RS flip-flop U1. The positive input terminal and the negative input terminal of the first comparator COM1 respectively receive the first node voltage Vsw and the output voltage Vo, and the output terminal outputs the first comparison signal. The set terminal of the first RS flip-flop U1 receives the rising edge or falling edge of the first turn-on signal VGTZ, and the reset terminal R is connected to the output terminal of the first comparator COM1, resetting at the generation time of the falling edge FP of the first comparison signal. That is, the first comparator COM1 resets the first RS flip-flop U1 when the first node voltage Vsw is less than the output voltage Vo. The first integration unit 221 includes a first voltage-controlled current source Al and a first capacitor C1 connected in series, and a first transistor M1 is connected across the two ends of the first capacitor C1. The control terminal of the first transistor M1 is connected to the inverted output terminal of the first RS flip-flop U1. The second integration unit 222 includes a second voltage-controlled current source A2 and a second capacitor C2 connected in series, and a second transistor M2 is connected across the two ends of the second capacitor C2. The control terminal of the second transistor M2 is connected to the inverted output terminal of the first RS flip-flop. Therefore, at the generation time of the rising edge RP or falling edge FP of the first turn-on signal VGTZ, the set terminal S is at a high level, the transistors M1 and M2 are turned off, the first node voltage Vsw charges and integrates the first capacitor C1 to generate VTsw, and the output voltage Vo charges and integrates the second capacitor C2 to generate VTvo. When Vsw begins to be less than Vo, the reset terminal R is at a high level, the transistors M1 and M2 are turned on, the first capacitor C1 and the second capacitor C2 discharge, and the integration is cleared. The transistors M1 and M2 can be NMOS transistors, and the first capacitor C1 and the second capacitor C2 are the same.

In one possible embodiment, the arithmetic unit 224 can be an adder, calculating the sum of the second integration voltage VTvo and the volt-second threshold VTth. The output terminal of the adder is connected to the negative input terminal of the comparator COM2, and the output terminal of the first integration unit 221 is connected to the positive input terminal of the comparator COM2. In another embodiment, the arithmetic unit 224 can be a subtractor, connected between the first integration unit 221 and the positive input terminal of the comparator COM2, used to calculate the difference between the first integration voltage VTsw and the threshold voltage VTth, and the output terminal of the second integration unit 222 is connected to the negative input terminal of the comparator COM2. In another embodiment, the arithmetic unit 224 can be a subtractor or a differential amplifier, with two input terminals respectively connected to the first integration unit 221 and the second integration unit 222, calculating the difference between the first integration voltage VTsw and the second integration voltage VTvo. The output terminal of the arithmetic unit 224 is connected to the positive input terminal of the comparator COM2, and the negative input terminal of the comparator COM2 receives the threshold voltage VTth. The comparator COM2 outputs the VTOK signal when (VTsw−VTvo)>VTth.

In another possible embodiment, the capacitor C2 and the transistor M2 are removed, and the output of the voltage-controlled current source A1 is subtracted from the output of the voltage-controlled current source A2, and then charges the capacitor C1 to calculate the volt-second product of (Vsw−Vo), outputting to the positive input terminal of the comparator COM2, and the negative input terminal of the comparator COM2 receives the threshold voltage VTth. In another embodiment, the capacitor C2, the transistor M2, and the voltage-controlled current source A2 are removed, and the control terminal voltage of the voltage-controlled current source A1 is replaced with (Vsw−Vo). The above embodiments can all achieve volt-second product calculation and can be possible implementations of the volt-second acquisition unit 220.

The counting unit 240 can include a frequency divider counter U2, a NOT gate U3, and an AND gate U4. The output terminal of the AND gate U4 is connected to the clock terminal of the counter U2, and the output terminal of the comparator COM2 is connected to the reset terminal RST of the counter U2. The output terminals of the counter U2 are D0, D1, and D2, which are divided by two in sequence. The output terminals of the counter U2 are connected to the input terminal of the NOT gate U3, and the output terminal of the NOT gate U3 is connected to one input terminal of the AND gate U4. The other input terminal of the AND gate U4 receives the rising edge of the first turn-on signal. The output terminal of the counter U2 is also connected to the alarm unit 250. Therefore, each time the volt-second product VT reaches the volt-second threshold VTth, the counter is reset to zero, and when the volt-second product VT is less than the volt-second threshold VTth, counting is performed, and the reading is taken each time the first turn-on signal arrives. A non-zero count value indicates a circuit fault, and an alarm signal can be output when there is a count in multiple switching cycles. In some application scenarios where alarm prompts are needed, the alarm signal generated by the alarm unit 250 can also be connected to external devices such as light-emitting diodes or buzzers through the chip's pins to control the operation of the light-emitting diodes or buzzers according to the alarm signal.

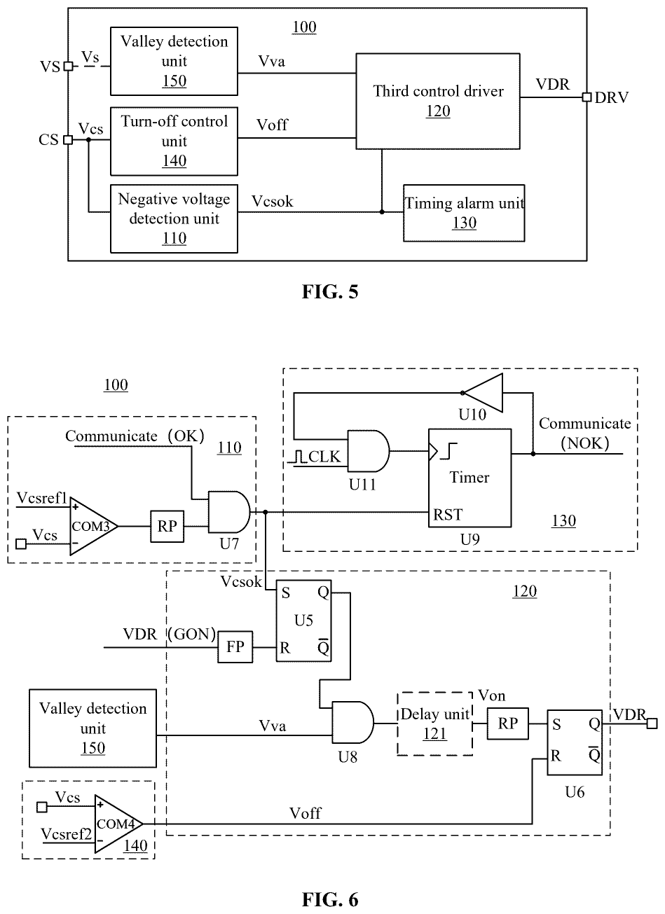

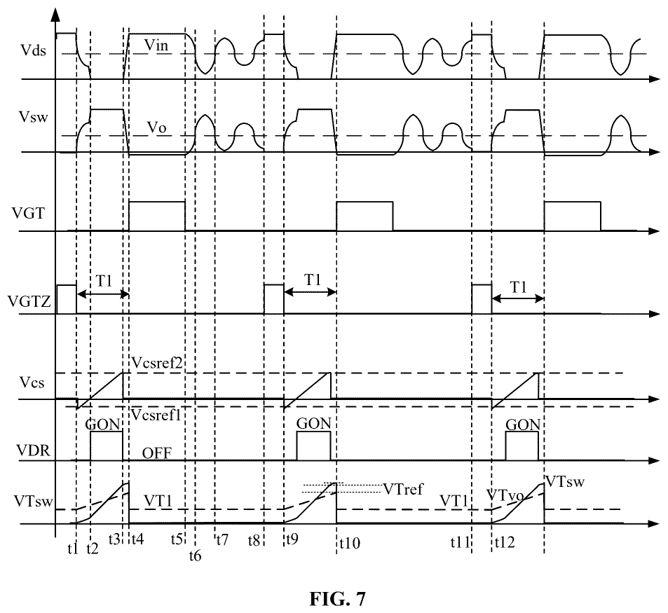

FIGS. 5 and 6 respectively show a schematic block diagram and a schematic circuit diagram of a primary side control circuit of a control circuit for a flyback converter according to an embodiment of the present disclosure.

As shown in FIGS. 5 and 6, the primary side control circuit 100 includes a negative voltage detection unit 110, a third control driver 120, a timing alarm unit 130, a turn-off control unit 140, and a valley detection unit 150. The negative voltage detection unit 110 detects the voltage signal Vcs across the sampling resistor Rcs and compares it with the first reference voltage Vcsref1. When the negative voltage detection unit 110 detects that the voltage signal Vcs is less than the first reference voltage Vcsref1, it outputs a first preparation signal Vcsok. The third control driver 120 is connected to the negative voltage detection unit 110 and outputs a third turn-on signal VDR (GON) to the main power transistor Q1 after receiving the first preparation signal Vcsok for a period of time, controlling the main power transistor Q1 to turn on. For example, after receiving the first preparation signal Vcsok, and after the valley detection unit 150 detects that the drain-source voltage of the main power transistor Q1 has dropped to a certain threshold, or the change rate of the drain-source voltage meets certain conditions, the main power transistor Q1 is turned on. The turn-off control unit 140 is used to detect the voltage signal Vcs across the sampling resistor Rcs and compare it with the second reference voltage Vcsref2. When the voltage signal Vcs is greater than the second reference voltage Vcsref2, a turn-off signal Voff is output. The third control driver 120 is connected to the turn-off control unit 140 and controls the main power transistor Q1 to turn off according to the turn-off signal Voff. The second reference voltage is a positive voltage. The valley detection unit 150 is used to detect physical quantities representing the drain-source voltage of the main power transistor Q1, such as the voltage across the auxiliary winding, the second node voltage Vs, or the change rate of the second node voltage Vs, etc., to determine the time when the drain-source voltage of the main power transistor Q1 drops to the valley. For example, the valley detection unit 150 can receive the second node voltage Vs from the VS pin and achieve valley detection through the second node voltage Vs. When the second node voltage Vs indicates that the drain-source voltage across the main power transistor Q1 has reached the valley (for example, reached zero voltage), a second preparation signal Vva is output. The third control driver 120 is connected to the valley detection unit 150 and outputs a third turn-on signal VDR (GON) to the main power transistor Q1 after receiving the first preparation signal Vcsok and the second preparation signal Vva, controlling the main power transistor to turn on. The timing alarm unit 130 is triggered by a clock signal to start timing, resetting upon receiving the first preparation signal Vcsok, and generating an alarm signal when continuously timing exceeds the second time period without resetting, at the same time, the primary side control circuit 100 be controlled to stop working, automatically restart, or enter a latch state, waiting for power-off restart.

As shown in FIG. 6, it is an exemplary circuit structure of the primary side control circuit 100 of the present disclosure, but it does not limit the present disclosure. In FIG. 6, the negative voltage detection unit 110 can include a comparator COM3 and an AND gate U7. The positive input terminal and the negative input terminal of the comparator COM3 respectively receive the first reference voltage Vcsref1 and the voltage signal Vcs, and the output terminal outputs the rising edge RP signal to the AND gate U7. The other input terminal of the AND gate U7 receives the state signal Communicate, which represents the circuit state. When no circuit fault is detected, a Communicate OK signal is generated, and when a circuit fault is detected, a Communicate NOK signal is generated. Alternatively, the Communicate OK signal and the Communicate NOK signal are inverse signals, for example, Communicate OK is 1, Communicate NOK is 0 by default, indicating normal communication, and Communicate OK is 0, Communicate NOK is 1 by default, indicating communication failure, handshake failure. The state signal received by the AND gate U7 is defaulted to OK, that is, defaulted to 1. For example, the valley detection unit 150 can include one comparator (not shown in the drawings), with the positive input terminal and the negative input terminal respectively receiving the reference voltage Vsref and the second node voltage Vs. Of course, the valley detection unit 150 can also have other circuit implementations, which are not described here. The turn-off control unit 140 includes a comparator COM4, with the positive input terminal and the negative input terminal respectively receiving the voltage signal Vcs and the second reference voltage Vcsref2.

The third control driver 120 includes a second RS flip-flop U5, a third RS flip-flop U6, an AND gate U8, and a delay unit 121. The set terminal S of the second RS flip-flop U5 is connected to the negative voltage detection unit 110, receiving the first preparation signal Vcsok, and the reset terminal R receives the falling edge FP of the third turn-on signal DRV (GON). That is, the RS flip-flop U5 is reset only after the third turn-on signal DRV (GON) ends. The first input terminal of the AND gate U8 is connected to the output terminal of the second RS flip-flop U5, and the second input terminal is connected to the valley detection unit 150 to receive the second preparation signal Vva. In another embodiment, after generating the first preparation signal Vcsok and the second preparation signal Vva, a delay is performed before turning on the main power transistor Q1, ensuring that the main power transistor Q1 is turned on with zero voltage, for example, a delay unit 121 is set. The delay unit 121 is connected between the output terminal of the AND gate U8 and the set terminal S of the third RS flip-flop U6, outputting a turn-on delay signal Von. Of course, the delay unit 121 can be removed, and the output terminal of the AND gate U8 is directly connected to the set terminal S of the third RS flip-flop U6. Alternatively, the delay unit 121 can be replaced with other circuits with similar functions. The set terminal S of the third RS flip-flop U6 receives the rising edge RP of the turn-on delay signal Von, and the reset terminal R is connected to the turn-off control unit 140, receiving the turn-off signal Voff. The output terminal outputs the drive signal VDR, which includes the third turn-on signal VDR (GON) and the turn-off control signal VDR (OFF). The third RS flip-flop U6 outputs the third turn-on signal VDR (GON) to turn on the main power transistor Q1 when the set terminal S receives the rising edge RP of the turn-on delay signal Von, and outputs the turn-off control signal VDR (OFF) to turn off the main power transistor Q1 when the reset terminal R receives the turn-off signal Voff.

Furthermore, the timing alarm unit 130 includes a timer U9, an AND gate U11, and a NOT gate U10. The reset terminal RST of the timer U9 is connected to the output terminal of the AND gate U7, receiving the first preparation signal Vcsok, to perform timing reset or reset. The output terminal of the timer U9 is connected to the alarm unit (not shown) and connected to the input terminal of the NOT gate U10. When the timing has not been reset for more than the second time period, the Communicate NOK signal is output. The output terminal of the NOT gate U10 is connected to one input terminal of the AND gate U11, and the other input terminal of the AND gate U11 receives the clock signal CLK.

The circuit diagrams of FIGS. 4 and 6 are only one possible implementation of the present disclosure and do not limit the control circuit of the present disclosure.

FIG. 7 shows a schematic waveform diagram of various signals when the switching power supply according to an embodiment of the present disclosure is operating normally.

As shown in FIG. 7, the switching power supply operates in DCM mode. The horizontal axis represents time, Vds represents the drain-source voltage across the main power transistor Q1, Vsw represents the first node voltage, VGTZ represents the first turn-on signal, VGT represents the second turn-on signal, Vcs represents the voltage signal across the sampling resistor, VDR represents the drive signal (high level represents the third turn-on signal GON, low level represents the turn-off control signal OFF), VTsw represents the first integration signal, VTvo represents the second integration signal, and VT1 represents the first volt-second product.

The waveform diagram of this embodiment can be in accordance with the circuits and control methods of FIGS. 1-6. Referring to FIG. 7, before time t1, the first turn-on signal VGTZ is generated. At time t1, the falling edge of the first turn-on signal VGTZ is generated, causing the voltage signal Vcs to reach the first reference voltage Vcsref1. During the time period t1-t2, the drain-source voltage Vds of the main power transistor Q1 decreases. At time t2, it is detected that the drain-source voltage Vds of the main power transistor Q1 has dropped to the valley or to the threshold voltage, for example, zero voltage. At this time, the main power transistor Q1 is turned on according to the third turn-on signal VDR (GON). During the time period t2-t3, the main power transistor Q1 continues to be turned on. At time t3, the voltage signal Vcs reaches the second reference voltage Vcsref2, and the main power transistor Q1 is turned off. From time t1, the volt-second product is calculated within the first time period T1, and VTsw and VTvo can be calculated separately according to FIG. 4. Since the falling edge of the first turn-on signal VGTZ is used as the start time of the first time period, VTto needs to be calculated in accordance with VT1. At time t4, Vsw begins to be less than Vo, which is the end time of the first time period, and the integration ends. At this time, VTsw is greater than (VTvo+VT1), and the difference is greater than VTref, where VTref is the volt-second reference value. It indicates that the main power transistor Q1 is operating normally, so the second turn-on signal VGT is generated at time t4. At time t5, the synchronous rectifier transistor Q2 is controlled to turn off. After time t5, the circuit enters the natural resonance state, and the time period t6-t7 is half a resonance period. At time t8, the next repeat cycle begins, and the first turn-on signal VGTZ is generated again. At time t9, it is detected that Vcs reaches the first reference voltage, and the main power transistor Q1 is turned on after a delay. During the time period t9-t10, the volt-second product is calculated and compared. At time t10, the synchronous rectifier transistor Q2 is turned on. At time t11, the next switching cycle begins, and the process repeats. The waveform of each signal in FIG. 7 represents the waveform when the system is operating normally.

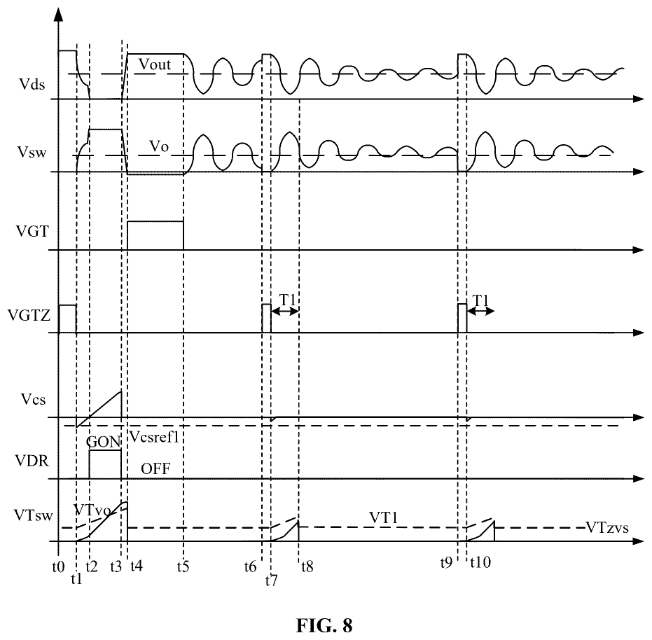

In some embodiments, a fault may occur in the primary side control circuit 100 or the secondary side control circuit 200. When a fault in the primary side control circuit 100 causes the main power transistor Q1 not to turn on as expected, or a fault in the secondary side control circuit 200 causes the Vcs voltage not to reach the negative voltage threshold, the main power transistor Q1 cannot turn on. At this time, the system resonates naturally, and the volt-second product cannot always exceed the volt-second threshold, so it is determined that the handshake between the primary and secondary sides has failed. When a fault in the secondary side control circuit 200 causes the drive not to be output, and Vcs cannot reach the negative voltage threshold, the main power transistor Q1 will also continue not to turn on. When Vcs has not reached the negative voltage threshold for more than a certain time, an alarm signal will be generated. See FIG. 8 for details.

FIG. 8 shows a schematic waveform diagram of various signals when a fault occurs in the primary side control circuit or the secondary side control circuit of the switching power supply according to an embodiment of the present disclosure.

As shown in FIG. 8, during the time period t0-t6, the system operates normally, and the working principle is the same as in FIG. 7, which will not be repeated here. At time t6, the first turn-on signal VGTZ is generated again, but the time period of this first turn-on signal VGTZ is relatively short, ending at time t7. At this time, at time t7, the Vcs voltage cannot be less than the first reference voltage Vcsref1, that is, the negative voltage information detection fails, and the main power transistor Q1 cannot turn on. At this time, the primary side control circuit 100 has started timing, and after timing exceeds the second time period (for example, multiple switching cycles), the negative voltage information cannot still be detected, and at this time, the primary side control circuit 100 outputs an alarm signal, and at the same time, the primary side control circuit 100 is stopped, entering a latch or automatic restart stage. Since the main power transistor Q1 is not turned on, the volt-second product calculated by the secondary side control circuit 200 within the time period T1 cannot exceed the volt-second threshold VTth, that is, during the time period t7-t8, the volt-second product cannot be detected to exceed the volt-second threshold. At this time, the secondary side control circuit 200 does not send the second turn-on signal VGT to the synchronous rectifier transistor Q2. At time t9, a new switching cycle begins, and the pulse width of the first turn-on signal VGTZ is still small, causing the primary side control circuit 100 to still not detect that the voltage Vcs across the sampling resistor reaches the negative voltage threshold Vcsref1, and the primary side control circuit 100 continues timing. During a period of time after time t10, the volt-second product detected by the secondary side control circuit 200 still cannot exceed the volt-second threshold VTth, and at this time, it can be determined that the handshake between the primary and secondary sides has failed, or after multiple switching cycles, the secondary side control circuit 200 outputs an alarm signal. When the secondary side control circuit 200 outputs an alarm signal, it also causes the first control driver to stop working and no longer sends the first turn-on signal VGTZ. After the primary side control circuit 100 generates an alarm signal, it can automatically restart or enter a latch state. After entering the latch state, it can wait for power-off restart and start working again, allowing the secondary side control circuit 200 to be powered again. Therefore, the communication between the primary and secondary sides can be judged in accordance with the voltage Vcs across the sampling resistor and the volt-second product, and appropriate measures can be taken when communication is not successful to ensure the normal operation of the circuit.

The control circuit and the control method for a flyback converter, and the switching power supply provided by the present disclosure enable the secondary side control circuit to send a first turn-on signal to the synchronous rectifier transistor according to a compensation signal to turn on the synchronous rectifier transistor, so that a negative current is generated on the main power transistor Q1. The presence of this negative current allows the main power transistor to achieve zero voltage switching (ZVS), reducing system loss. The primary side control circuit detects the voltage signal across the sampling resistor, and when the voltage signal is less than the first reference voltage, it is considered that a negative current has been generated, indicating that the primary side control circuit has received the control command from the secondary side control circuit, allowing it to execute the control command to turn on the main power transistor. The secondary side control circuit calculates the volt-second product of the voltage across the secondary winding within the first time period after generating the first turn-on signal and compares the volt-second product with the volt-second threshold to determine the communication status between the primary side control circuit and the secondary side control circuit. The volt-second product, if being greater than the volt-second threshold, indicates a successful handshake between the primary side control circuit and the secondary side control circuit, thereby completing the handshake communication between the primary and secondary sides without an isolator. Through the above control circuit and control method, the secondary side control circuit can act as the main control chip, controlling and determining the operating state of the primary side control circuit, achieving handshake communication without an isolator, reducing circuit area and system cost, and lowering power consumption.

Furthermore, if the volt-second determination unit does not detect that the volt-second product is greater than the volt-second threshold during the time period in which the first control driver generates two or even multiple first turn-on signals, it is determined that the primary side control circuit may not have executed the control command, and the primary side control circuit may have a fault. At this time, it is determined that the handshake between the primary side control circuit and the secondary side control circuit has failed. Alternatively, if the primary side control circuit does not detect that the voltage signal is less than the first reference voltage after continuously exceeding the second time period, it is considered that the secondary side control circuit may not have sent the control command, and the secondary side control circuit may have a fault. At this time, it is also determined that the handshake between the primary side control circuit and the secondary side control circuit has failed. Therefore, the circuit can be accurately judged whether it is communicating normally in accordance with two judgment parameters, and appropriate measures can be taken in a timely manner when communication is not normal, improving the accuracy of communication interaction and ensuring circuit safety.

Furthermore, after the secondary side control circuit determines that the main power transistor has successfully turned on in accordance with the volt-second product, it can output a second turn-on signal to the synchronous rectifier transistor and adjust the length of the switching period by controlling the generation timing of the first turn-on signal, thereby adjusting the switching frequency. The secondary side control circuit achieves closed-loop control, determining the system's operating frequency and the turn-on timing of the main power transistor, ensuring the stability and reliability of system communication.

Furthermore, when calculating the volt-second product, the influence of the volt-second product on the secondary winding during the period when the synchronous rectifier transistor is turned on after receiving the first turn-on signal is considered, avoiding misjudgment caused by changes in the volt-second product when the main power transistor is not turned on but the synchronous rectifier transistor is already turned on, thereby avoiding the phenomenon of simultaneous conduction of the synchronous rectifier transistor and the main power transistor.

It should be noted that the numerical values in this document are only for exemplary illustration, and in other embodiments of the present disclosure, other numerical values can also be sampled to implement the present solution. Specific settings should be made reasonably according to actual conditions, and the present disclosure is not limited to this.

Finally, it should be noted that the above embodiments are merely examples made to clearly illustrate the present disclosure and are not limitations on the implementation methods. For those skilled in the art, other different forms of changes or variations can be made in accordance with the above description. It is not necessary to exhaust all implementation methods here. The obvious changes or variations derived from this are still within the protection scope of the present disclosure.

It should also be understood that the terms and expressions used herein are only for description, and one or more embodiments of this specification should not be limited to these terms and expressions. The use of these terms and expressions does not imply the exclusion of any equivalent features of the illustration and description (or part thereof), and it should be recognized that various modifications that may exist should also be included within the scope of the claims. Other modifications, variations, and replacements may also exist. Accordingly, the claims should be considered to cover all such equivalents.

What is claimed is:

1. A control circuit for a flyback converter, the flyback converter comprising a transformer, the transformer including a primary winding and a secondary winding, the flyback converter further comprising a main power transistor coupled to the primary winding and a synchronous rectifier transistor coupled to the secondary winding, wherein the control circuit of the flyback converter comprises a primary side control circuit and a secondary side control circuit, the secondary side control circuit comprising:
a first control driver configured to send a first turn-on signal to the synchronous rectifier transistor in accordance with a compensation signal to turn on the synchronous rectifier transistor, so that a negative current is generated on the main power transistor;
a volt-second acquisition unit configured to calculate the volt-second product of the voltage across the secondary winding within a first time period after generating the first turn-on signal;
a volt-second determination unit configured to compare the volt-second product with a volt-second threshold to determine communication status between the primary side control circuit and the secondary side control circuit,
wherein the volt-second product, if being greater than the volt-second threshold, indicates a successful handshake between the primary side control circuit and the secondary side control circuit,
the compensation signal represents an error between an output feedback signal and a reference signal of the flyback converter.

2. The control circuit according to claim 1, wherein the volt-second product, if being greater than the volt-second threshold, indicates that the primary side control circuit has received and executed a control command from the secondary side control circuit to turn on the main power transistor.

3. The control circuit according to claim 2, wherein the primary side control circuit turns on the main power transistor after detecting that a drain-source voltage of the main power transistor reaches a valley.

4. The control circuit according to claim 2, wherein the flyback converter further comprises a sampling resistor coupled to the main power transistor,
the primary side control circuit detects a voltage signal across the sampling resistor to determine whether the secondary side control circuit has sent the control command, the voltage signal, if being less than a first reference voltage, indicates that the secondary side control circuit has sent the control command, and the first reference voltage is a negative voltage, wherein the primary side control circuit, in response to the control command, controls the main power transistor to be turned on after detecting that the voltage signal is less than the first reference voltage.

5. The control circuit according to claim 1, wherein if the volt-second determination unit does not detect that the volt-second product is greater than the volt-second threshold during the time period from generating the M-th first turn-on signal to generating the N-th first turn-on signal, it is determined that the primary side control circuit has not executed the control command, and the handshake between the primary side control circuit and the secondary side control circuit has failed, wherein M is greater than or equal to 1, N is greater than 1, and N is greater than M.

6. The control circuit according to claim 5, wherein the secondary side control circuit, after determining that the handshake between the primary side control circuit and the secondary side control circuit has failed, controls the first control driver to stop working.

7. The control circuit according to claim 4, wherein the primary side control circuit, after a second time period is exceeded without detecting that the voltage signal is less than the first reference voltage, indicates that the handshake between the primary side control circuit and the secondary side control circuit has failed.

8. The control circuit according to claim 7, wherein the primary side control circuit, after determining that the handshake between the primary side control circuit and the secondary side control circuit has failed, automatically restarts or performs fault latching and waits for power-off restart.

9. The control circuit according to claim 5, wherein the secondary side control circuit further comprises:
a second control driver configured to send a second turn-on signal to the synchronous rectifier transistor to turn it on when the volt-second product is greater than the volt-second threshold and a drain-source voltage of the synchronous rectifier transistor decreases below a threshold voltage.

10. The control circuit according to claim 9, wherein the second control driver is coupled to the volt-second determination unit, and stops working when the volt-second determination unit determines that the primary side control circuit has not executed the control command.

11. The control circuit according to claim 1, wherein the first control driver adjusts generation timing of the first turn-on signal in accordance with the compensation signal to adjust the length of switching period.

12. The control circuit according to claim 1, wherein the secondary side control circuit further comprises:
a freewheeling determination unit configured to determine the operating state of the synchronous rectifier transistor in accordance with a first node voltage at the connection node of the secondary winding and the synchronous rectifier transistor, wherein the first control driver send the first turn-on signal to the synchronous rectifier transistor when the freewheeling determination unit has detected an end of freewheeling of the synchronous rectifier transistor and an operating frequency reaches a preset frequency obtained according to the compensation signal.

13. The control circuit according to claim 1, wherein the volt-second acquisition unit comprises:
an integration calculation unit configured to perform integration calculation in accordance with the first node voltage at the connection node of the secondary winding and the synchronous rectifier transistor and the output voltage within the first time period to obtain the volt-second product;
a volt-second reset unit configured to set the first time period, control the integration calculation unit to start working at the start of the first time period, and control the integration calculation unit to clear the volt-second product at the end of the first time period.

14. The control circuit according to claim 13, wherein the volt-second reset unit sets the time point that a rising edge of the first turn-on signal occurs as the start of the first time period, and the volt-second threshold is a volt-second reference value.

15. The control circuit according to claim 13, wherein the volt-second reset unit sets the time point that a falling edge of the first turn-on signal occurs as the start of the first time period, and the volt-second threshold is the sum of a volt-second reference value and a first volt-second product, wherein the first volt-second product is generated by performing an integration operation based on a voltage across the secondary winding during an on time of the synchronous rectifier transistor controlled by the first turn-on signal.

16. The control circuit according to claim 14, wherein the volt-second reference value is greater than a second volt-second product generated based on the voltage across the secondary winding during parasitic decay oscillation, and the volt-second reference value is less than a third volt-second product generated based on the voltage across the secondary winding during an on time of the main power transistor.

17. The control circuit according to claim 15, wherein the volt-second reference value is greater than a second volt-second product generated based on the voltage across the secondary winding during parasitic decay oscillation, and the volt-second reference value is less than a third volt-second product generated based on the voltage across the secondary winding during an on time of the main power transistor.

18. The control circuit according to claim 6, wherein the secondary side control circuit further comprises:
a counting unit configured to count the number of pulses of the first turn-on signal and clear the count value when the volt-second determination unit determines that the volt-second product is greater than the volt-second threshold; and
an alarm unit configured to output an alarm signal when the count value of the counting unit exceeds a preset value, to provide the alarm signal to the first control driver, or to provide the alarm signal simultaneously to the first control driver and the second control driver.

19. The control circuit according to claim 7, wherein the primary side control circuit comprises:
a negative voltage detection unit configured to detect the voltage signal across the sampling resistor and compare it with the first reference voltage, and to output a first preparation signal when detecting that the voltage signal is less than the first reference voltage;
a third control driver configured to output a third turn-on signal to the main power transistor after receiving the first preparation signal, controlling the main power transistor to be turned on; and
a timing alarm unit triggered by a clock signal to start timing, resetting upon receiving the first preparation signal, and generating an alarm signal when continuously timing exceeds the second time period without resetting.

20. A control method for a flyback converter, the flyback converter comprising a transformer, the transformer including a primary winding and a secondary winding, the flyback converter further comprising a main power transistor coupled to the primary winding and a synchronous rectifier transistor coupled to the secondary winding, wherein the control method of the flyback converter comprises:
sending a first turn-on signal to the synchronous rectifier transistor in accordance with a compensation signal to turn on the synchronous rectifier transistor, so that a negative current is generated on the main power transistor;
calculating the volt-second product of the voltage across the secondary winding within a first time period after generating the first turn-on signal;
comparing the volt-second product with a volt-second threshold to determine communication status between the primary side control circuit and the secondary side control circuit, wherein the volt-second product, if being greater than the volt-second threshold, indicates a successful handshake between the primary side control circuit and the secondary side control circuit,
the compensation signal represents an error between the output feedback signal and the reference signal of the flyback converter.

21. The control method according to claim 20, wherein the volt-second product, if being greater than the volt-second threshold, indicates that the primary side control circuit has received and executed the control command from the secondary side control circuit to turn on the main power transistor.

22. The control method according to claim 20, further comprising:
determining that the primary side control circuit has not executed the control command and the handshake between the primary side control circuit and the secondary side control circuit has failed if the volt-second product is not detected to be greater than the volt-second threshold during the time period from generating the M-th first turn-on signal to generating the N-th first turn-on signal, wherein M is greater than or equal to 1, N is greater than 1, and N is greater than M.

23. The control method according to claim 20, wherein the flyback converter further comprises a sampling resistor coupled to the main power transistor, the control method further comprising:
detecting a voltage signal across the sampling resistor to determine whether the secondary side control circuit has sent the control command, the voltage signal, if being less than a first reference voltage, indicating that the secondary side control circuit has sent the control command, the first reference voltage being a negative voltage;
controlling the main power transistor to be turned on in response to the control command after detecting that the voltage signal is less than the first reference voltage.

24. The control method according to claim 23, further comprising:
indicating that the handshake between the primary side control circuit and the secondary side control circuit has failed if the voltage signal is not detected to be less than the first reference voltage after a second time period is exceeded.

25. The control method according to claim 20, further comprising:
sending a second turn-on signal to the synchronous rectifier transistor to turn it on when the volt-second product is greater than the volt-second threshold and the drain-source voltage of the synchronous rectifier transistor decreases below a threshold voltage.

26. The conduction control method according to claim 20, wherein the step of sending a first turn-on signal to the synchronous rectifier transistor in accordance with a compensation signal to turn on the synchronous rectifier transistor, so that a negative current is generated on the main power transistor, comprises:
sending the first turn-on signal to the synchronous rectifier transistor when an end of freewheeling of the synchronous rectifier transistor has been detected and an operating frequency reaches a preset frequency obtained according to the compensation signal, and adjusting the length of switching period by adjusting the generation timing of the first turn-on signal.

27. A switching power supply comprising a flyback converter, the flyback converter comprising a transformer, the transformer including a primary winding and a secondary winding, the flyback converter further comprising a main power transistor coupled to the primary winding and a synchronous rectifier transistor coupled to the secondary winding, wherein the switching power supply further comprises:
the control circuit of the flyback converter according to claim 1, the control circuit of the flyback converter being configured to control operating states of the main power transistor and the synchronous rectifier transistor.
